(19) United States
(12) Patent Application Publication
(10) Pub. No.: US 2015/0344325 A1
(43) Pub. Date: Dec. 3, 2015

(54) DEVICE AND METHOD FOR SOLAR DISTILLATION

(71) Applicants: Tim Broeckelmann, Dortmund (DE); Lothar Frauenkron, Dortmund (DE); Sven Huelskoetter, Dortmund (DE)

(72) Inventor: TIM BROECKELMANN, Dorimund (DE)

(21) Appl. No.: 14/729,235

(22) Filed: Jun. 3, 2015

(30) Foreign Application Priority Data
Jun. 3, 2014 (DE) DE202014102597.9
Sep. 16, 2014 (DE) DE102014113291.2

(51) Int. Cl. C02F 1/14; B01D 3/00

(52) U.S. Cl. CPC C02F 1/14; B01D 3/00; C02F 2201/3228

(57) ABSTRACT

The invention relates to a device for the distillation of a liquid, with at least one mirror surface (24, 24a, 124) for focusing solar radiation onto an absorber tube (14, 14a, 114) which can be filled at least partly with the liquid, wherein the absorber tube (14, 14a, 114), is provided, for taking up energy from the solar radiation and for evaporating the liquid, and to at least one first condensation tube (22, 22a, 122) for condensing the evaporated liquid, the first condensation tube (22, 22a, 122) being disposed at a distance from the absorber tube (14, 14a, 114), to which it is coupled by at least one distillation bridge (20, 20a, 120). In order to make a simple and cost effective distillation device possible, with which a particularly efficient utilization of the solar energy for a high distillation performance is achieved, it is provided that a transparent sleeve (16, 16a, 116) is coupled thermally with the condensation tube (22, 22a, 122) and surrounds the absorber tube (14, 14a, 114), a space (18, 18a, 118) remaining between the sleeve (16, 16a, 116), and the absorber tube (14, 14a, 114).

### FIELD OF THE INVENTION

The invention relates to a device and to a method for distilling a liquid. In particular, the invention relates to a distillation device and a distillation method which is supplied with energy by solar radiation.

### BACKGROUND OF THE INVENTION

As a separation method, the distillation has manifold applications in technology. Distillation is utilized with different starting liquids, particularly in the chemical industry area.

Distilled water finds extensive use in various industrial areas, such as solvents or cleaning agents. However, a high input of energy is required for the distillation.

The use of solar energy for operating a distillation device is known per se. The DE-OS 26 04 978 describes a distillation device which can be operated with solar energy and for which the liquid which is to be distilled, such as water, is separated from an air space by a silicone membrane. The silicone membrane is sinusoidal in shape and glued to a cover of glass or a different material which transmits solar energy. The solar energy which is radiated through the cover, is absorbed by the silicone membrane, so that vapor can penetrate through the membrane and condense at the underside of the cover.

The AT 507 782 A4 describes a portable solar thermal device for producing fresh water from effluent or salt water. The device exhibits a closed fluid cycle. This consists of tube or hose elements which are connected with one another, with a waste water inlet and a fresh water outlet. The fluid cycle comprises a heating section for heating and evaporating the effluent. The heating section has a partially transparent, insulating casing, so that solar radiation can pass through the casing and reach a solar collector. The solar collector is able to concentrate the thermal energy of the solar radiation on an evaporation surface located in the interior of the heating section. A perpendicular condensing section, in which the freshwater can condense and the effluent may be pre-heated, adjoins the heating section.

A light and compact solar still which has a two-part distillation chamber and an adjustable solar collector is described in US 2008/0 073 198 A1. The distillation chamber comprises mainly two parts, a trough and a cover. Liquid which is to be distilled is disposed in the trough. Preferably, the underside is blackened, so that heating the liquid for distillation is simplified. The distillate can condense at the cover and is discharged via troughs. The cover may be transparent and have cooling ribs which improve condensation.

A solar still for sea water is disclosed in U.S. Pat. No. 4,504,362 A. Preferably, the solar still is configured so that the solar collector which focuses light on an absorber tube can function as a float. The sea water is heated and evaporated by solar radiation in the absorber tube which is connected via distillation bridges with a condensation tube. The condensation tube preferably is arranged below the water line, so that it is cooled by seawater and the condensation of the vapor can be improved.

In the U.S. Pat. No. 4,749,447 A, a solar still is described, for which the absorber tube and the condensation tube are coupled thermally with one another, so that the heat of condensation can be used to heat the liquid in the absorber tubes. The coupling is accomplished directly via heat-conducting elements, such as metal ribs, the walls of the tubes or a concentric arrangement of a condensation tube in an absorber tube. The absorber tubes and the condensation tubes are connected with one another via distillation bridges. The distillation bridges have valves and pumps, so that the pressure is higher in the condensation tubes than in the absorber tubes. As a result, condensation of the distillate can also become possible at higher temperatures. The tubes may be disposed in a partly or completely transparent casing which preferably is gas tight.

### SUMMARY OF THE INVENTION

It is an object of the invention to propose a simple and cost effective distillation device, with which a high distillation performance will be achieved with a particularly efficient utilization of the energy of the sun.

According to the invention, this objective is accomplished by a device of claim 1 and a method of claim 14. Dependent claims relate to advantageous embodiments of the invention.

The device according to the invention first of all has an absorber tube. This can be filled at least partly with the liquid which is to be distilled, so that the liquid reservoir formed is in thermal contact with the wall of the absorber tube.

A mirror surface serves to focus solar radiation in the area of the absorber tube, so that the absorber tube is warmed up by absorbing energy from the radiation of the sun. With sufficient warming up, a portion of the liquid evaporates in the absorber tube.

The absorber tube is coupled via a distillation bridge at least with one first condensation tube, so that vapor is passed into the first condensation tube. The vapor condenses in the first condensation tube. It is disposed at a distance from the absorber tube to which it preferably is parallel.

According to the invention, a transparent sleeve is provided which is coupled thermally with the condensation tube and encloses the absorber tube. Moreover, the sleeve passes at a distance from the absorber tube, so that an interstice remains as a space between the sleeve and the absorber tube. As is evident in conjunction with preferred embodiments, the sleeve need not be formed continuously from one material; instead, different elements and materials may jointly form a sleeve which encloses the absorber tube.

Due to the transparency of the sleeve, light radiation from the latter can unimpededly hit the absorber tube. The transparent sleeve does not need to be transparent over the whole of its area, but it has to be transparent at least partly. The sleeve is transparent at least in the area of the thermal coupling with the condensation tube. Furthermore, the sleeve is transparent in those regions from which light rays can hit the absorber tube. If light radiation is not to be expected from certain regions of the sleeve, since these regions, for example, are covered by other parts of the device, such as the condensation tube, the sleeve need not necessarily also be transparent at these sites. It may even be appropriate that the sleeve or parts thereof have reflecting properties at such sites, so that incident light beams from a different side can be reflected onto the absorber.

Due to the device according to the invention, it becomes possible to utilize the heat of condensation and the increase the efficiency. During the condensation at the condensation tube, the latter is heated by the released heat of condensation. The sleeve, surrounding the absorber tube, is also being heated due to the thermal coupling with the condensation tube. Preferably, the sleeve is gas tight, so that, a closed insulated space is formed from which essentially no heat escapes by convection. For this, it may already be sufficient if the insulated space is closed off to such an extent that, for example, it is wind tight. Moreover, the insulated space can be closed off so tightly, that a gas which fills it is contained at a pressure higher or lower than atmospheric pressure, down to a vacuum.

Accordingly, the absorber tube is in an insulated space within the sleeve which is kept at a higher temperature than the surroundings due to the heating. Because of this, there is also a higher temperature at the absorber tube, since the direct environment of the latter is heated and the absorber tube therefore emits less heat to its surroundings.

Due to this additional utilization of the heat of condensation, a particularly efficient distillation process is possible with the device according to the invention. As a result of the increased temperature of the absorber tube, less intensive solar radiation is already sufficient for distilling water and it is also possible to evaporate liquids with a higher boiling point.

Moreover, due to the tubular construction and preferred parallel arrangement of an absorber and a condenser, the construction of the device according to the invention is particularly efficient and the device can be produced cost-effectively.

In advantageous embodiments, the absorber tube, the condensation tube and the sleeve may be constructed as tubes with different cross-sectional shapes. These comprise round or predominately round, cross-sectional shapes as well as, for example, triangular or other cross-sectional shapes. For example, in a round sleeve, the absorber tube may be disposed centrally, so that if, for example, the cross-section of the absorber tube is also round, the sleeve always has the same distance from the wall of the absorber tube. Temperature difference in the absorber tube can be avoided by these means.

In some embodiments, the sleeve can also be formed partly by regions of the mirror, for example, the base thereof. For example, a transparent pane in, for example, a trough-shaped or parabolic mirror can be inserted so that this pane, as an outer pane, together with the mirror, can form a sleeve about the absorber tube which is transparent in the direction of the incident light rays. This makes a simplified construction of the sleeve possible and, nevertheless, irradiation of light from many directions onto the absorption tube.

It is advantageous if the sleeve consists at least partly of a glass, preferably with advantageous heat conduction properties, and a high transmission, such as borosilicate glass. Furthermore, transparent plastic, such as Plexiglas for example, may also be used.

Advantageously, the absorber tube is disposed in the device so that it is at a focal point of the mirror surfaces. Preferably, it may have a circular or polygonal cross-section. According to a further embodiment of the invention, the cross-section of the absorber tube is triangular, especially equilaterally triangular. In this connection, an acute angled triangle, for example, with an angle of less than 60° between the sides of equal length, is preferred. With such a cross-section, the long sides of the triangle may be aligned with respect to the mirror surfaces, so that the greatest amount of radiation can strike the absorber tube. The efficiency of the device can be increased further in this way.

In preferred further embodiments of the device, the absorber tube consists of a corrosion resistant and vapor resistant material which preferably is thermally stable, such as stainless steel, glass or certain polymers. For an improved absorption of light, it is advantageous if the absorber tube is blackened or, in the case of a metal tube, galvanized.

Preferably, the first condensation tube is disposed in direct contact with the transparent sleeve in order to transfer the heat, resulting from the condensation, to the sleeve by conduction. If the sleeve is constructed as a tube, the condensation tube may, for example, be arranged at the inside of the tube. For a further embodiment of the invention, in which the sleeve consists at least partly of a transparent plate, for example, a glass plate in the optical path, the condensation tube may be disposed directly in contact with the transparent plate. In a preferred embodiment, two transparent plates are disposed at an angle to one another, the condensation tube being disposed in contact with one of the transparent plates.

It is particularly preferred if in the last-mentioned case the second transparent plate, as an inner pane, extends from the first transparent plate which is disposed as an outer pane, up to the mirror, preferably to its base. By these means, two insulated spaces can be formed. The absorber tube, distillation bridge and condensation tube may then be disposed in a first insulated space. In the second insulated space, either this construction may be repeated or this chamber may be used, for example, for storing heat. During operation of the device, this reservoir may be supplied, to begin with, by excess heat. If there are fluctuations in the solar radiation, for example, due to cloudiness, the stored heat may be used as a buffer and intercept these fluctuations. As a result, the distillation can proceed more uniformly which represents a gain in efficiency.

In order to achieve passive cooling, the first condensation tube may be disposed in thermal coupling with the mirror surface, preferably in direct contact with the mirror surface. According to a further embodiment of the invention, the first condensation tube may, moreover, be connected to a second condensation tube, so that vapor which does not condense in the first condensation tube reaches the second condensation tube. The second condensation tube may be disposed so that it is in thermal contact with the mirror surface. An efficient, passive cooling, namely the delivery of heat of the second condensation tube, is made possible in this way, so that the condensation of the still remaining vapor, is achieved. Alternatively or additionally, active cooling can also be used.

According to a further embodiment of the invention, it is furthermore preferred if a desired liquid level is achieved in the absorber tube by means of a valve. In particular, provisions can be made here so that the valve permits liquid to flow in only as far as a desired maximum level. For example, the valve may be controlled with a float.

In a further embodiment of the invention, the mirror surface is constructed in the shape of a trough, the absorber tube being disposed within the trough-shaped mirror surface. Such a structure can be realized particularly well in large installations, wherein several troughs which are to be disposed parallel to one another over an area being preferred. The trough-shaped arrangement, moreover, is particularly advantageous if at least the mirror surface and preferably also the absorber tube is disposed so that it can be rotated about a longitudinal axis, in order to enable tracking relative to the sun. A rotation of the whole unit of a mirror surface, absorber tube, sleeve, and first condensation tube is particularly preferred.

Advantageously, a heat exchanger may be provided in order to preheat the liquid, supplied to the absorber tube, by means of the condensate. The efficiency of the device is increased herewith.

According to a further embodiment of the invention, a collection container for the condensate may be provided, preferably underneath the mirror surface. In this context, it is particularly preferred if the collection container is provided as a foundation for carrying at least the mirror surface and the absorber tube.

According to a further embodiment of the invention, the distillation bridges can form a connection space between absorber tube and condensation tube, through which vapor from the absorber tube can be passed into the condensation tube in which it condenses. Preferably, in the space between the absorber tube and the condensation tube through which the evaporated fluid flows, a material may be disposed which is to be extracted, that is, dissolved by the vapor flowing through. Preferably, a material which contains another material that is to be extracted, for example, as a constituent or as an impurity, may be disposed in the connection space. Accordingly, the vapor flowing through can be utilized for the extraction. It dissolves the material to be extracted and transports it along.

According to a further embodiment, an insert for accommodating the substance or material contained by this may be disposed in the connection space. It may be possible to insert this or slide it in.

According to a further embodiment, the insert may be constructed as a container with a wall which is permeable for the evaporated liquid, for example, as a screen (also as a perforated sheet of metal), for example, of steel, or by using a silicone membrane. In general, an insert should be impermeable for the material itself, but permeable for the vapor and, with that, for the transported extracted materials.

Accordingly, the substance or the material to be treated can be held in the transition between the absorber reservoir and the condensation space and passage of the vapor through this region can be enabled.

A method according to the invention for solar distillation comprises a focusing of solar radiation through the mirror surface onto the absorber tube filled at least partly with liquid. The absorber tube takes up the energy from the solar radiation and evaporates the liquid. The vapor flows through a distillation bridge from the absorber tube to the condensation tube. The condensation tube is coupled thermally with a transparent sleeve which encloses the absorber tube so that a space remains between the absorber tube and the sleeve. The vapor condenses in the condensation tube. During the condensation, heat is released which heats up the condensation tube. Heat is transferred to the sleeve via the thermal coupling of the condensation tube and the transparent sleeve. The heated sleeve heats the space in-between, as a result of which the absorber tube delivers less thermal energy to the latter. The method according to the invention therefore makes condensation enthalpy usable for increasing the efficiency of solar distillation. Due to this increase in efficiency, a solar still can still be operated effectively even at higher latitudes or with less solar radiation and the distillation of materials with a higher boiling point is possible.

### BRIEF DESCRIPTION OF THE DRAWINGS

Embodiments of the invention are described in greater detail in the following by means of drawings, in which

FIG. 1 shows a diagrammatic representation of a first embodiment of a solar distillation device in cross section and

FIG. 2 shows a diagrammatic representation of a longitudinal section through the device of FIG. 1 1.

FIG. 3 shows a diagrammatic representation of a second embodiment of a solar distillation device in cross section

FIG. 4 shows a diagrammatic representation of a third embodiment of a solar distillation device in cross section, with a possibility for extraction

FIG. 5 shows an enlargement of a portion of the representation of FIG. 4 and

FIG. 6 shows a diagrammatic representation of a longitudinal section through the device of FIGS. 4 and 5.

### DETAILED DESCRIPTION OF THE PREFERRED EMBODIMENTS

In the drawings, the various embodiments of distillation installations are shown in diagrammatic representations, with which a liquid which has been supplied, can be distilled by using only the energy of solar light. In this connection, utilization to obtain distilled water is just as possible as the distillation of other starting liquids. For the sake of simplification, the distillation is always started out from water in the following; however, the invention is not limited to this.

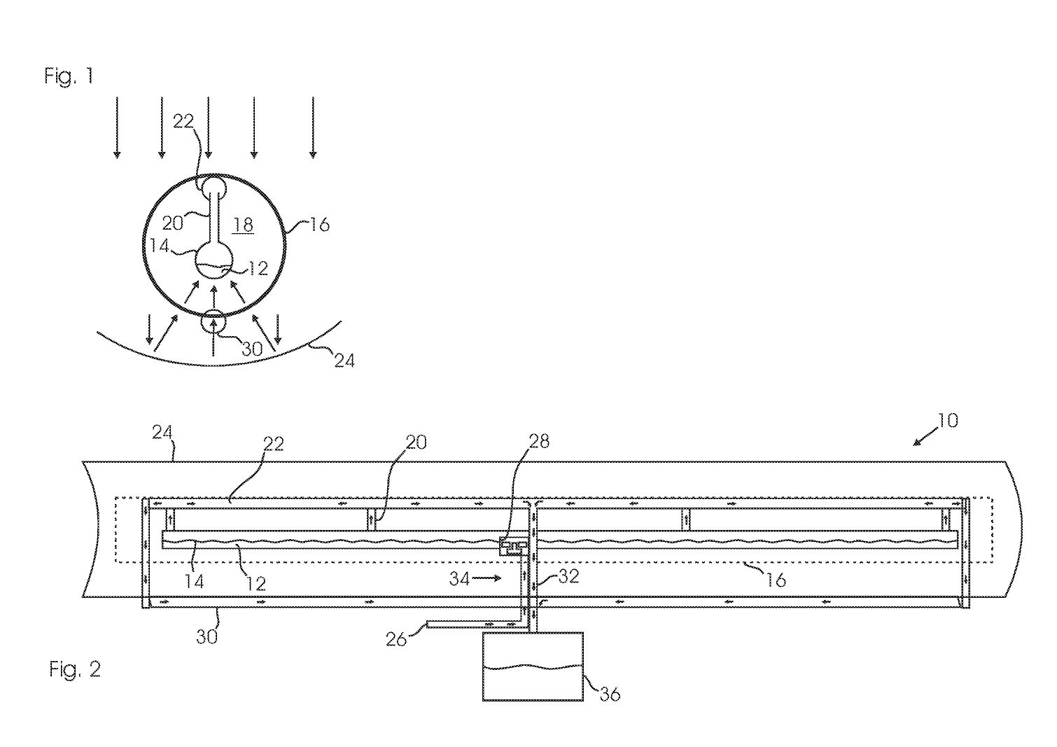

FIGS. 1 and 2 show a first embodiment of a distillation installation 10. As is evident, first of all from the diagrammatic cross-sectional representation in FIG. 1, the water 12 which is to be distilled is in the interior of an absorber tube 14. The absorber tube 14 is disposed within a gas tight transparent sleeve 16 which may be formed, for example, from glass. The absorber tube 12 accordingly is located in a closed-off insulated space 18 in the interior of the sleeve 16.

The absorber tube 14 is connected with a first condensation tube 22 via several distillation bridges 20, of which one is shown in FIG. 1. Sunlight radiation, shown here by arrows, is reflected by a suitably curved mirror surface 24 and focused in the direction of the absorber tube 14. By these means, the absorber tube 14, is heated up for evaporating the liquid 12 contained therein, the vapor of which then passes through the distillation bridge 20 into the condensation tube 22.

The sleeve 16 is fastened directly to the condensation tube 22, with which it is in direct thermal contact. If the vapor condenses in the condensation tube 22, an amount of heat of condensation, corresponding to the evaporation enthalpy, is transferred to the condensation tube 22 and to the sleeve 16 which is coupled thermally thereto.

Accordingly, the sleeve 16 is heated, so that the absorber tube 14 is in the interior of the heated insulated space 18. Due to this arrangement of the absorber tube 14 in the heated insulated space 18 within the also heated sleeve 16, the absorber tube 14 emits less thermal energy to the surroundings. With that, the absorber tube 14 attains a higher temperature with the same solar radiation, than would be the case with an arrangement without the sleeve 16, that is, if the absorber tube 14 were to be exposed directly to the external environment.

Accordingly, by utilizing the heat of condensation, the distillation installation 10 with the construction shown diagrammatically in FIG. 1 achieves a clear increase in efficiency due to the utilization of the heat of condensation. This can be used, on the one hand, in order to achieve a high throughput during the distillation, even if the solar radiation is relatively slight. On the other hand, the higher temperature at the absorber tube 14 can also be used for the distillation of liquids, the boiling point of which is above that of water.

The further construction of the installation 10 is shown in longitudinal section in FIG. 2. The mirror reflector 24 is constructed in the shape of a trough. The absorber tube 14 and the first condensation tube 22 are disposed at a distance from and parallel to one another and coupled with one another by several distillation bridges 20.

Water (or a different liquid which is to be distilled) is passed via an inlet 26 and through a float valve 28 to the absorber tube 14. With the help of the float valve 28, it is ensured that a desired liquid level is always maintained within the absorber tube 14.

If the whole of the liquid does not condense in the first condensation tube 22, the excess vapor can be passed into a second condensation tube 30. The second condensation tube 30 extends parallel to the first condensation tube 22, as well as to the absorber tube 14 and is disposed directly at the mirror surface 24, so that it is in thermal contact with the mirror surface 24. By these means, a large surface for delivering heat is available to the second condensation tube 30, so that it is ensured that the excess vapor will condense.

The distillate, obtained in the first condensation tube 22 and in the second condensation tube 30, is passed via a pipeline 32 into a collection container 36. Moreover, a heat exchanger 34 is provided, the details of which are not shown, with which the fresh water, supplied to the absorber tube 14, is heated by the condensate.

The collection container 36 forms a foundation for the installation 10. The mirror surface 24 and the unit of absorber tube 14, first condensation tube 22, and the sleeve 16, are supported on the collection container 36. Moreover, the whole trough from the mirror reflector 24 and the sleeve 16, with the tubes 14, 22 therein, can be rotated about a longitudinal axis, so that tracking relative to the position of the sun is made possible.

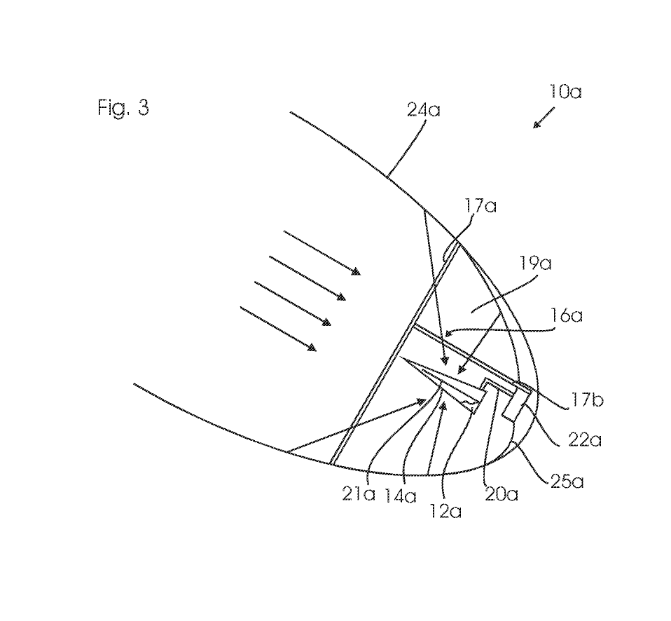

A second embodiment of a distillation device 10a is shown in FIG. 3. The water 12a which is to be distilled is disposed in an absorber tube 14a with a triangular cross-section, the center of which is at the focal point of a curved mirror 24a. The absorber tube 14a is connected with a condensation tube 22a which extends parallel to the absorber tube 14a and has a rectangular cross-section in the example shown, via distillation bridges 20a one of which is shown here. The absorber tube 14a, as well as the condensation tube 22a is disposed in an insulated space 18a which is surrounded by a partially transparent sleeve 16a.

A partition 21a extends into the absorber tube 14a and leaves a region in the tip of the latter free. In the absorber tube 14a, this partition 21a differentiates a region with liquid from a passage to the distillation bridge 20a. As a result, the liquid cannot reach the distillation bridge 20a directly.

In the example shown, the sleeve 16a is formed by a rear wall 25a of the mirror 24a and two transparent elements 17a, b which consists of a glass with a high transmission. The one transparent element 17a is disposed as an outer pane between the upper and lower mirror sides, so that rays of light, incident frontally on the distillation installation 10a, hit them perpendicularly. The other transparent element extends as an inner pane 17b from the outer pane 17a to the rear wall 25a of the mirror 24a and forms a right angle with the outer pane 17a. As a result, the inner pane 17b separates the insulated space 18a from a region 19. The inner pane 17 is in contact with the condensation pipe 22a, with which it is coupled thermally by these means.

Incident light rays are focused by the mirror 24a onto the absorber tube 14a. Due to the triangular acute angled cross section of the latter, most of the rays, preferably, strike the two long sides and, in this way, heat the absorber pipe 14a uniformly. At the same time, the water 12a evaporates in the absorber tube 14a. The vapor flows around the partition 21a and reaches the condensation tube 22a by way of the distillation bridges 20a.

The vapor may condense once again in the condensation tube 22a. The thereby released energy of condensation can then heat the condensation tube 22a which transfers this heat to the inner pane 17b, and with that to the sleeve 16a.

In addition, the condensation tube 22a is coupled thermally with the rear wall 25a. Due to the delivery of the energy of condensation to the mirror 24a, on the one hand, passive cooling can be achieved and, on the other, the region of the mirror 24a which forms part of the sleeve 16a, is heated with the rear wall 25a. By these means, the sleeve 16a can be heated further.

In addition to being heated by solar radiation, the insulated space 18a is therefore also heated by way of the sleeve 16a. Owing to the fact that it is disposed within the insulated space 18a, the absorber tube 14 can therefore reach higher temperatures than if it were outside of this space 18a. In addition to the thermal insulation by the sleeve 16a, this effect is increased even more by the thermal coupling of the condensation tube 22a with the sleeve 17a.

The region 19a forms a further insulation chamber which can also be heated and functions as a thermal reservoir for the insulation space 18a. By these means, weather-related fluctuations in the temperature and solar radiation can be intercepted, so that a more uniform operation of the solar still 10a is ensured.

This second embodiment therefore offers a similar gain in efficiency when the solar radiation is utilized, like the first embodiment shown in FIGS. 1 and 2. This gain in efficiency can therefore also be used in order to distill relatively larger amounts in a corresponding time with a relatively low solar radiation or to make possible the distillation of liquids, the boiling points of which is above that of water.

The second embodiment may also comprise further elements which are described for the first embodiment. For example, a heat exchanger (not shown), with which the freshwater, supplied to the absorber tube, is heated by the condensate, may be provided at a pipeline to a collection container for the distillate.

In addition, a floating valve may be provided in the inlet to the absorber tube 14a. With the help of the floating valve, it is ensured that a desired water level (or a level of a different liquid which is to be distilled) is always retained within the absorber tube 14.

Moreover, in the second embodiment, a second condensation tube may be provided which extends parallel to the first condensation tube 22a as well as to the absorption tube 14a and is disposed directly at the mirror surface 24, so that it is in thermal contact with the mirror surface 24. A large area for emitting heat is therefore available to the second condensation tube. This ensures that the excess vapor is condensed.

The decisive improvement of these distillation installations, 10, 10a over known solar stills lies in the utilization of the heat of condensation. This is achieved by the sleeves 16, 16a. Because of the airtight construction thereof, heat losses are minimized. Moreover, the sleeves 16, 16a, are heated in particular by conduction by being disposed at the first condensation tube 22, 22a. Depending on the design, the sleeve 16, 16a may consist partly or completely of a special solar glass (such as a low iron glass or a borosilicate glass) for optimized thermal radiation properties.

A plurality of supplements or respectively modifications is possible in addition, and/or, alternatively to the versions and elements shown. For example, the curved mirror surface 24 may be constructed in different shapes, for example, as a parabolic trough. All parts which are in contact with the liquid or the vapor, may be produced from appropriate stainless steel (such as WNr.1.4301 X5CrNii8-i0, AISI 304 (V2A)) which is resistant to foods as well as to corrosion and, at the same time, has good stability. The absorber tube 14, 14a may be blackened for better light absorption and, with that, easier heating.

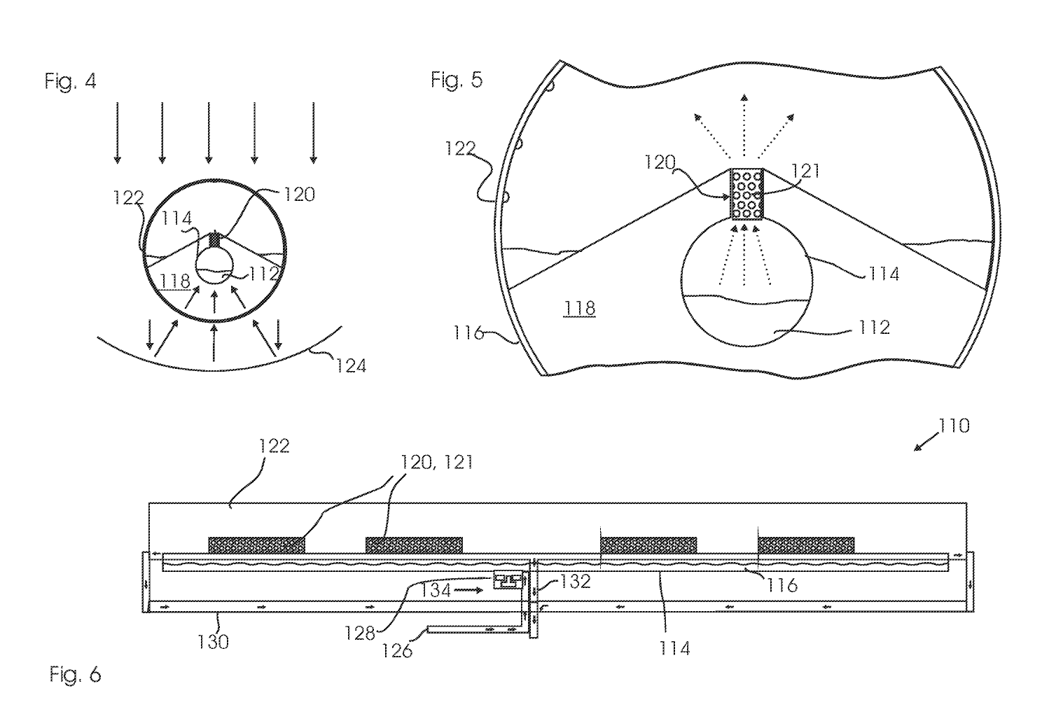

A third embodiment of an installation 110, based on the first embodiment shown in FIG. 1, is shown in FIGS. 4-6. The installation 50 is intended for the extraction of substances from a material, by using the vapor obtained during the distillation.

In the third embodiment, distillation bridges 120 which connect an absorber tube 114 with a first condensation tube 122, are expanded into connection spaces 120 in comparison to the distillation bridges 20 of the first embodiment. Sunlight radiation, shown by arrows in FIG. 4, is reflected by a suitably curved mirror surface 124 and focused in the direction of the absorber tube 114.

The absorber tube 114, is heated by the sunlight until the liquid 112, contained therein, starts to evaporate and the vapor of the liquid 112 then passes through the connection space 120 and reaches the condensation tube 122. In the example shown, the condensation tube has a cross section which, instead of being round, is in the shape of a segment of a circle.

In the connection space 120 between the absorber tube 114 and the condensation tube 122, a material (not shown), from which a substance is to be extracted, is disposed in an insert 121. The insert 121, is constructed so that the material to be treated is held therein and itself does not reach the absorber tube 114 or the condensation tube 122. However, the vapor flowing through the connection space 120, can pass through the insert 121 and comes into contact with the material, resulting in the desired effect of extraction of the material.

The material which is not shown in the drawings, may, for example, be a plant material, from which contents are to be extracted. This is accomplished by means of the vapor flowing through which in contact with the material within the insert 121 extracts the contents there and transports them into the condensation tube 122. The extracted substance is then dissolved in the condensate which forms there.

In a different application example, the insert 121 contains a material which is to be purified, such as spent activated charcoal which previously was used as a filter and therefore is interspersed with impurities. Here also, the vapor, flowing through the connection space 120, comes into contact with the activated charcoal in the insert 121, dissolves the impurities there and transports them away. The activated charcoal can be purified and regenerated in this way, so that it can subsequently be used once again as a filter material.

The inserts 121 in the respective connection spaces 120 are shown only diagrammatically in the Figures between the absorber tube 114 and the condensation tube 122. Several inserts 121 (four separate inserts 121 in FIG. 6) are shown over the length of the device in the example. Of course, a different number of passages 120 with inserts 121 therein may be provided. Likewise, the connection space 120, and the insert 121 may extend therein continuously over the whole length.

The inserts are to be adapted to the material which is to be treated. In the example shown, the inserts 121 are constructed as closed containers with a perforated wall, so that vapor can flow through them, but any solids, such as activated charcoal are retained.

In general, the wall of the insert 121 should be constructed so that it retains the material which is to be treated, but permits passage of the vapor and of the substance which is to be extracted.

Depending on the material to be treated and the substance to be extracted, an insert 121 may be equipped, for example, with a membrane which is permeable for the vapor and for the material to be extracted. This membrane may, for example, be a silicone material.

Preferably, the insert 121 can be exchanged. For example, the tubular or trough-shaped device may be hinged as a whole, so that the inserts 121 can be exchanged in order to remove material which has been treated and to insert new material which is to be treated. The inserts 121 can be used as cartridges so that, for example, filled inserts are removed and replaced by newly filled inserts 121.

In an alternative embodiment (not shown), the different inserts 121 or respectively a continuous insert 121 can be pushed in the longitudinal direction into the device.

There has thus been shown and described a novel device and method for solar distillation which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A device for distilling a liquid with
at least one mirror surface for focusing solar radiation onto an absorber tube which can be filled at least partly with the liquid, wherein the absorber tube is provided for taking up energy from solar radiation and for evaporating the liquid,
at least one first condensation tube for condensing the evaporated liquid, wherein the first condensation tube is disposed at a distance from the absorber tube and is coupled with it by at least one distillation bridge,
wherein a transparent sleeve is provided which is coupled thermally with the condensation tube and surrounds the absorber tube, wherein a space remains between the sleeve and the absorber tube.

2. The device according to claim 1, wherein
the transparent sleeve forms a gas tight, closed-off insulation space.

3. The device according to claim 1, wherein
the absorber tube has a triangular cross-section.

4. The device according to claim 1, wherein
at least one transparent pane, together with a portion of the mirror surface forms the transparent sleeve
and the transparent pane is coupled thermally with the condensation tube.

5. The device according to claim 4, wherein
a first transparent pane is disposed between two mirror surfaces,
a second transparent pane is attached to the first one at an angle
and the transparent pane is coupled thermally with the condensation tube.

6. The device according to claim 1, wherein
the first condensation pipe is disposed in contact with the sleeve in order to transfer heat, evolved during the condensation, by conduction to the sleeve.

7. The device according to claim 1, wherein
the first condensation tube is connected to a second condensation tube for accommodating and for condensing uncondensed vapor,
the second condensation tube is in thermal contact with the mirror surface.

8. The device according to claim 1, wherein
a valve is provided for filling the absorber tube with the liquid to a desired level.

9. The device according to claim 1, wherein
the mirror surface is constructed in the form of a trough,
and the absorber tube is disposed within the trough-shaped mirror.

10. The device according to claim 1, wherein
a heat exchanger is provided in order to preheat the liquid, supplied to the absorber tube by means of the condensate.

11. The device according to claim 1, wherein
an insert for accommodating a substance or material is disposed in the distillation bridge.

12. The device according to claim 1, wherein
an insert for accommodating a substance or material is disposed in the distillation bridge.

13. The device according to claim 11, wherein
the insert is constructed as a container with a wall which is permeable to the evaporated liquid.

14. The device according to claim 11, wherein
the insert is constructed as a screen.

15. A method for the solar distillation of a liquid, wherein
at least one mirror surface focuses solar radiation on an absorber tube, which is filled at least partly with a liquid,
the absorber tube taking up energy from the solar radiation and evaporating the liquid,
the evaporated liquid flows through a distillation bridge from the absorber tube into at least one condensation tube and condenses there, the condensation tube being disposed at a distance from the absorber tube,
wherein a transparent sleeve is provided which is coupled thermally with the condensation tube and surrounds the absorber tube, a space remaining between the sleeve and the absorber tube.
